(19) United States
(12) Patent Application Publication
(10) Pub. No.: US 2025/0059027 A1
(43) Pub. Date: Feb. 20, 2025

(54) SYSTEM FOR PRODUCING HYDROGEN BY AMMONIA DECOMPOSITION REACTION AND HYDROGEN PRODUCTION METHOD

(71) Applicants: FUZHOU UNIVERSITY, Fuzhou (CN); FZU ZIJIN HYDROGEN POWER TECHNOLOGY CO., LTD, Fuzhou City (CN)

(72) Inventors: Lilong Jiang, Fuzhou (CN); Yu Luo, Fuzhou (CN); Li Lin, Fuzhou (CN); Chongqi Chen, Fuzhou City (CN); Qing Zhang, Fuzhou City (CN)

(73) Assignees: FUZHOU UNIVERSITY, Fuzhou (CN); FZU ZIJIN HYDROGEN POWER TECHNOLOGY CO., LTD, Fuzhou City (CN)

(21) Appl. No.: 18/804,321

(22) Filed: Aug. 14, 2024

(30) Foreign Application Priority Data
Aug. 16, 2023 (CN) 2023110335636

(51) Int. Cl. C01B 3/04; B01D 53/04; B01J 8/02; C01B 3/56

(52) U.S. Cl. CPC C01B 3/047; B01D 53/0423; B01D 53/0446; B01J 8/0278; B01J 8/0285; C01B 3/56; B01D 2256/10; B01D 2256/16; B01D 2257/406; B01D 2259/40086; B01J 2208/00256; C01B 2203/043; C01B 2203/0833; C01B 2203/0883

(57) ABSTRACT

The invention discloses a system for producing hydrogen by ammonia decomposition reaction and a hydrogen production method. The system comprises an ammonia storage device, a heat exchange device, an ammonia decomposition reaction device, a first compression device and a first adsorption device, and the ammonia storage device is in communication with a gas inlet of the ammonia decomposition reaction device through a cold liquid channel on the heat exchange device; and a gas outlet of the ammonia decomposition reaction device is in communication with the first adsorption device through a gas channel on the heat exchange device by means of the first compression device communicating with the first adsorption device; the first adsorption device comprises a plurality of adsorption columns arranged in parallel, the first compression device is in communication with inlets of a plurality of the adsorption columns at the same time, a control valve is arranged between the adsorption inlet of each adsorption column and the first compression device, and the adsorption outlets of a plurality of adsorption columns communicate with each other, a control valve is provided between adsorption outlets of two adjacent adsorption columns, and the adsorption inlet of each adsorption column is in communication with the ammonia decomposition reaction device. The system realizes cyclic utilization of tail gas after desorption of the adsorption column, and reduces the damage of ammonia gas and nitrogen oxides to the environment.

### TECHNICAL FIELD

This invention relates to the field of clean energy equipment, and in particular to a system for producing hydrogen by ammonia decomposition reaction and a hydrogen production method.

### BACKGROUND

Hydrogen is a green and clean energy source with abundant sources, and has the characteristics of high energy density, high calorific value, abundant reserves, wide sources, and high conversion efficiency, also produces water after combustion and has no carbon emissions. However, the transportation and storage of hydrogen are key problems that restrict the promotion and application of hydrogen energy technology. Ammonia is a carbon-free, hydrogen-rich carrier. Storing hydrogen with ammonia has unique advantages such as high energy density, easy storage and transportation, high safety, mature industrial foundation and zero carbon emissions at the terminal. Using ammonia as a hydrogen storage carrier, hydrogen can be produced on-site at the energy terminal through the ammonia decomposition reaction, and hydrogen-nitrogen mixed gas or high-purity hydrogen can be directly produced. Producing hydrogen by ammonia decomposition reaction is a key reaction process in the “ammonia-hydrogen” energy technology route. In this process, ammonia is decomposed through thermal catalysis to produce hydrogen and nitrogen with a volume fraction of 3:1. Due to the limitations of thermodynamic equilibrium, a small amount of undecomposed ammonia still exists in the hydrogen-nitrogen mixture after the decomposition of ammonia. It is usually necessary to remove the low-concentration ammonia to the ppm level or even lower through adsorption before it can be used for downstream applications. However, in long-term use, an adsorbent will reach saturation and cannot continue to adsorb ammonia, requiring regular desorption and regeneration. In the existing technology, it is usually necessary to set up more than two adsorption columns to stagger the “adsorption-desorption” cycle to meet the long-term gas supply for the ammonia decomposition hydrogen production system. In the desorption process of the existing process, not only does additional N₂ need to be prepared to purge the adsorption column, which increases the raw material cost of the system, but the adsorbed ammonia is still inevitably released, and if not treated, it will still be directly discharged into the atmosphere, or converted into higher concentration nitrogen oxides (NOₓ) through combustion and emitted into the atmosphere. Both NH₃ and NOₓ are pollutants that need to be controlled in the atmosphere. In order to truly realize clean and efficient “ammonia-hydrogen” conversion and utilization, it is necessary to effectively control the emission of ammonia or nitrogen oxides generated during the continuous operation of the system.

Chinese patent CN208308426U discloses a device for producing hydrogen by ammonia decomposition, which comprises a bottom plate, a box, a first adsorption tower and a second adsorption tower, wherein the box is located above the bottom plate, a heat insulation board is provided in the box, and a heat exchanger is provided above the heat insulation board, a valve is provided between the heat exchanger and the box, one end of the heat exchanger passes through the box and is provided with a valve, the other end of the heat exchanger passes through the heat insulation board and is connected to the interior of the decomposition furnace, an air pipe is provided at the lower end of the decomposition furnace, the air pipe passes through the box and is connected to the first adsorption tower and the second adsorption tower, wherein molecular sieves are provided in the first adsorption tower and the second adsorption tower, the first adsorption tower is connected to the second adsorption tower through a valve. In this patent, liquid ammonia is converted into ammonia gas through a heat exchanger, and then the ammonia gas is converted into nitrogen and hydrogen through a decomposition furnace to reduce the damage to the ammonia environment, and then the decomposed hydrogen and nitrogen gas is passed into the adsorption tower for adsorption to improve the gas purity of hydrogen and nitrogen. The device for producing hydrogen by ammonia decomposition in this patent requires additional nitrogen to purge the adsorption tower, and the saturated adsorption tower needs to be unloaded during the purging process. The system raw materials cost is high and the adsorption efficiency is poor, and there is a risk of ammonia leakage and damage to the environment during the adsorption process.

### SUMMARY OF THE INVENTION

In view of the shortcomings of the existing technology, the present invention proposes a system for producing hydrogen by ammonia decomposition reaction and a hydrogen production method. This system does not discharge ammonia gas and nitrogen oxides during adsorption, which is suitable for long-term gas supply through ammonia decomposition and has low decomposition raw material costs, high energy utilization and less energy consumption.

The present invention adopts the following technical solutions:

A system for producing hydrogen by ammonia decomposition reaction comprises an ammonia storage device, a heat exchange devic, an ammonia decomposition reaction device, a first compression device and a first adsorption device, wherein a liquid outlet of the ammonia storage device is in communication with a gas inlet of the ammonia decomposition reaction device through a cold liquid channel on the heat exchange device, and a gas outlet of the ammonia decomposition reaction device is in communication with the first compression device through a gas channel on the heat exchange device, the liquid ammonia discharged from the ammonia storage device is heat-exchanged with the mixed gas discharged from the ammonia decomposition reaction device through the heat exchange device, and the heat-exchanged gas is introduced into the first compression device;

the first adsorption device comprises a plurality of adsorption columns arranged in parallel, an outlet of the first compression device is in communication with adsorption inlets of a plurality of adsorption columns arranged in parallel at the same time, wherein a control valve is provided on a pipeline between the adsorption inlet of each adsorption column and the first compression device, the adsorption outlets of a plurality of adsorption columns communicate with each other, a control valve is provided between adsorption outlets of two adjacent adsorption columns, the adsorption inlet of each adsorption column is also in communication with a gas inlet of the ammonia decomposition reaction device through a pipeline, a control valve is provided on a pipeline between the adsorption inlet of each adsorption column and the ammonia decomposition reaction device, when the control valves between the adsorption outlets of two adjacent adsorption columns is opened, the mixed gas adsorbed by the adsorption columns is passed into the ammonia decomposition reaction device through one of the adsorption inlets of adsorption columns.

Preferably, the heat exchange device comprises a first heat exchanger and a second heat exchanger, and the first heat exchanger is provided with a first cold liquid inlet, a first cold liquid outlet, a first hot gas inlet and a first hot gas outlet, the first cold liquid inlet and the first cold liquid outlet serve as a communicated pair, and the first hot gas inlet and the first hot gas outlet serve as a communicated pair; the second heat exchanger is provided with a second cold gas inlet, a second cold gas outlet, a second hot gas inlet and a second hot gas outlet, the second cold gas inlet and the second cold gas outlet serve as a communicated pair, the second hot gas inlet and the second hot gas outlet serve as a communicated pair, the liquid outlet of the ammonia storage device is in communication with the gas inlet of the ammonia decomposition reaction device successively through the first cold liquid inlet, the first cold liquid outlet, the second cold gas inlet and the second cold gas outlet, and gas outlet of the ammonia decomposition reaction device is in communication with an inlet of the first compression device successively through the second hot gas inlet, the second hot gas outlet, the first hot gas inlet and the first hot gas outlet; the first heat exchanger can perform heat exchange between the gas discharged from the second heat exchanger and the gas discharged from the ammonia storage device, and discharge the heat-exchanged gas out of the first heat exchanger; the second heat exchanger can introduce the gas discharged from the first heat exchanger into the ammonia decomposition reaction device, and perform heat exchange between the gas discharged from the first heat exchanger and the gas discharged from the ammonia decomposition reaction device, and re-introduce the heat-exchanged gas back to the first heat exchanger.

A second compression device is also provided on a pipeline between the first adsorption device and the gas inlet of the ammonia decomposition reaction device;

a regulating valve is provided on a pipeline between the first cold liquid outlet and the second cold gas inlet; and an air cooling device is also provided on a pipeline between the second hot gas outlet and the first hot gas inlet.

An inlet end and an outlet end of the first compression device, and an inlet end and an outlet end of the second compression device are provided with buffer tanks.

Preferably, the first adsorption device comprises a first adsorption column and a second adsorption column arranged in parallel, and a first control valve, a second control valve, a third control valve, a fourth control valve, a five control valve, a sixth control valve and a seventh control valve which are arranged at an adsorption inlet and an adsorption outlet of the first adsorption device, wherein the first adsorption column is provided with a first adsorption inlet and a first adsorption outlet, the second adsorption column is provided with a second adsorption inlet and a second adsorption outlet, wherein a first pipe is provided between the first adsorption inlet and the second adsorption inlet, the first adsorption outlet is in communication with the second adsorption outlet through a second pipe, and a third pipe is connected in parallel under the first pipe, a fourth pipe is provided on the first adsorption outlet, and a fifth pipe is provided on the second adsorption outlet; the first control valve is provided between the first compression device and the first adsorption inlet, the third control valve is provided between and the first compression device and the second adsorption inlet, the fifth control valve is provided on the second pipe, the second control valve is provided on the fourth pipe, a fourth control valve is provided on the fifth pipe, and a sixth control valve is provided between the first adsorption inlet and the ammonia decomposition reaction device, and a seventh control valve is provided between the second adsorption inlet and the ammonia decomposition reaction device.

The system further comprises a buffer device and a second adsorption device, and the second adsorption device comprises a plurality of adsorption columns arranged in parallel, the adsorption outlet of the adsorption column on the first adsorption device is in communication with one end of the buffer device, and the other end of the buffer device is in communication with the adsorption inlet of the adsorption column on the second adsorption device.

Preferably, the second adsorption device comprises a third adsorption column and a fourth adsorption column arranged in parallel, and an eighth control valve, a ninth control valve, a tenth control valve, an eleventh control valve, a twelfth control valve, a thirteenth control valve and a fourteenth control valve which are arranged at an adsorption inlet and an adsorption outlet of the second adsorption device, wherein the third adsorption column is provided with a third adsorption inlet and a third adsorption outlet, the fourth adsorption column is provided with a fourth adsorption inlet and a fourth adsorption outlet, wherein a sixth pipe is provided between the third adsorption inlet and the fourth adsorption inlet, the third adsorption outlet is in communication with the fourth adsorption outlet through a seventh pipe, and an eighth pipe is connected in parallel under the sixth pipe, a ninth pipe is in communication with the third adsorption outlet, a tenth pipe is in communication with the fourth adsorption outlet; the sixth pipe is provided with the thirteenth control valve near the third adsorption column, and the sixth pipe is provided with the fourteenth control valve near the fourth adsorption column, the eighth control valve is provided between the buffer device and the third adsorption inlet, the tenth control valve is provided between the buffer device and the fourth adsorption inlet, the twelfth control valve is provided on the seventh pipe, and the ninth control valve is provided on the ninth pipe, and the eleventh control valve is provided on the tenth pipe.

The system further comprises a combustion device, the third adsorption inlet of the third adsorption column and the fourth adsorption inlet of the fourth adsorption column are in communication with an inlet of the combustion device respectively, and an outlet of the combustion device is in communication with the ammonia decomposition reaction device.

The system further comprises a hydrogen fuel cell, and the adsorption outlet of the first adsorption device is in communication with the hydrogen fuel cell, an outlet end of the hydrogen fuel cell is in communication with the inlet of the combustion device, and the outlet of the combustion device is in communication with the ammonia decomposition reaction device.

A hydrogen production method adopting a system for producing hydrogen by ammonia decomposition reaction comprises the following steps:
S1. introducing liquid ammonia into a heat exchange device and heating the liquid ammonia to above 550° C.;
S2. introducing ammonia gas into an ammonia decomposition reaction device to perform ammonia decomposition reaction;
S3. discharging a decomposed mixed gas from the ammonia decomposition reaction device and cooling the decomposed mixed gas to room temperature;
S4. introducing a cooled mixed gas into a first compression device for compression;
S5. introducing the mixed gas compressed by the first compression device into a first adsorption column of a first adsorption device, so that the first adsorption column adsorbing the mixed gas until the first adsorption column reaching a saturated state, and while adsorbing, 5% to 15% of the mixed gas in the first adsorption column being directed to a second adsorption column to purge the second adsorption column;
S6. discharging the purged mixed gas from the second adsorption column, and re-introducing it into the ammonia decomposition reaction device to perform the ammonia decomposition reaction;
S7. introducing the mixed gas compressed by the first compression device into the second adsorption column of the adsorption device, so that the second adsorption column adsorbing the mixed gas until the second adsorption column reaching a saturated state, and while adsorbing, 5% to 15% of the mixed gas in the second adsorption column being directed to the first adsorption column to purge the first adsorption column;
S8. discharging the purged mixed gas from the first adsorption column, and re-introducing it into the ammonia decomposition reaction device for ammonia decomposition reaction;
S9. performing steps S5-S8 repeatedly in a circulating mode.

The technical solution of the present invention has the following advantages:
A. By setting up a plurality of heat exchangers and using valves to control the adsorption columns in the adsorption device, the present invention can realize the simultaneous adsorption and desorption of the adsorption columns, and improve the adsorption efficiency of the system by adopting the solution of a plurality of adsorption columns being arranged in parallel; the purge gas purging the adsorption column is returned to the inlet of the ammonia decomposition reactor after being compressed by the compressor, and merges with the preheated ammonia gas before entering the ammonia decomposition reactor to realize ammonia recycling of the desorbed outlet gas, achieving 100% utilization of ammonia.
B. The entire system of the present invention only provides a hydrogen-nitrogen mixed gas (75% H₂+25% N₂) after deep adsorption to remove ammonia, without other tail gas emissions, reducing the risk of ammonia and nitrogen oxides damaging the environment, achieving zero emissions for the entire system, and improving the purity of hydrogen in the mixed gas; the ammonia decomposition reaction device decomposes the ammonia and then connects to the adsorption device for adsorption, after the adsorption is completed, part of the mixed gas is used to purge the adsorption column saturated with adsorption, without the need to introduce an additional gas source as a purge gas, thereby reducing the raw material cost and energy consumption of the system, improving the compactness of the system and also reducing environmental pollution during the production process.

### BRIEF DESCRIPTION OF THE DRAWINGS

In order to explain the specific embodiments of the present invention more clearly, the drawings needed to be used in the specific implementations will be briefly introduced below. Obviously, the drawings in the following description are some embodiments of the present invention. For those skilled in the art, other drawings can also be obtained based on these drawings without exerting creative work.

FIG. 1 is a schematic diagram (I) of the overall structure of a system for producing hydrogen by ammonia decomposition reaction according to the present invention;

FIG. 2 is a schematic diagram (II) of the overall structure of a system for producing hydrogen by ammonia decomposition reaction according to the present invention;

FIG. 3 is a schematic diagram (III) of the overall structure of a system for producing hydrogen by ammonia decomposition reaction according to the present invention;

FIG. 4 is a schematic diagram (IV) of the overall structure of a system for producing hydrogen by ammonia decomposition reaction according to the present invention;

FIG. 5 is a schematic diagram (V) of the overall structure of a system for producing hydrogen by ammonia decomposition reaction according to the present invention.

The reference signs in the drawings are as follows:

1—ammonia storage device, 11—stop valve, 12—liquid pump;

2—heat exchange device, 21—first heat exchanger, 211—first cold liquid inlet, 212—first cold liquid outlet, 213—first hot gas inlet, 214—first hot gas outlet, 22—second heat exchanger, 221—second cold gas inlet, 222—second cold gas outlet, 223—second hot gas inlet, 224—second hot gas outlet, 23—regulating valve, 24—air cooling device;

3—ammonia decomposition reaction device, 31—gas inlet, 32—gas outlet;

4—first compression device;

5—first adsorption device, 51—first adsorption column, 511—first adsorption inlet, 512—first adsorption outlet, 52—second adsorption column, 521—second adsorption inlet, 522—second adsorption outlet, 53—first pipe, 54—second pipe, 55—third pipe, 56—fourth pipe, 57—fifth pipe;

6—second compression device;

7—buffer device;

8—second adsorption device, 81—third adsorption column, 811—third adsorption inlet, 812—third adsorption outlet, 82—fourth adsorption column, 821—fourth adsorption inlet, 822—fourth adsorption outlet, 83—sixth pipe, 84—seventh pipe, 85—eighth pipe, 86—ninth pipe, 87—tenth pipe;

9—combustion device;

10—hydrogen fuel cell;

20—connecting device;

a—first control valve, b—second control valve, c—third control valve, d—fourth control valve, e—fifth control valve, f—sixth control valve, g—seventh control valve, h—eighth control valve, i—ninth control valve, j—tenth control valve, k—eleventh control valve, m—twelfth control valve, n—thirteenth control valve, and p—fourteenth control valve.

### DETAILED DESCRIPTION

The technical solution of the present invention will be clearly and completely described below with reference to the accompanying drawings. Obviously, the described embodiments are some, not all, of the embodiments of the present invention. Based on the embodiments of the present invention, all other embodiments obtained by those skilled in the art without creative efforts fall within the scope of protection of the present invention.

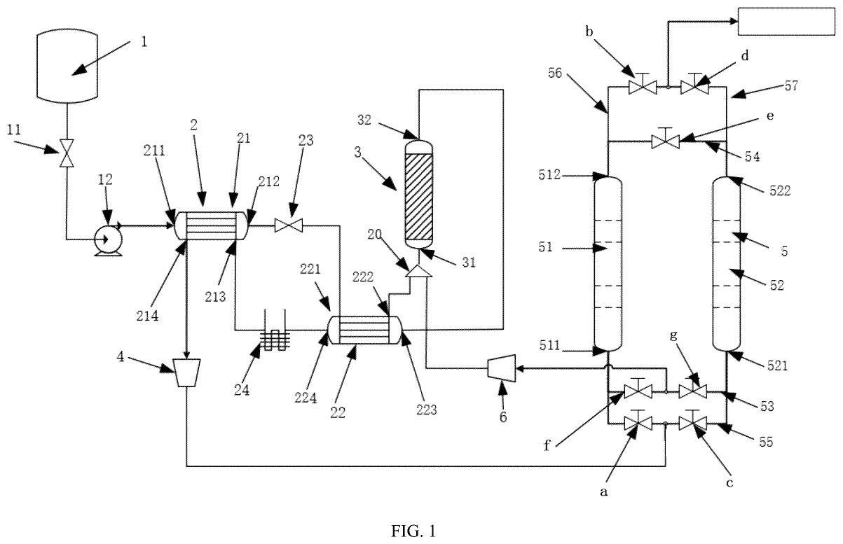

As shown in FIG. 1, the present invention provides a system for producing hydrogen by ammonia decomposition, comprising an ammonia storage device 1, a heat exchange device 2, an ammonia decomposition reaction device 3, a first compression device 4 and a first adsorption device 5. The ammonia decomposition reaction device 3 is filled with an ammonia decomposition catalyst. A liquid outlet of the ammonia storage device 1 is in communication with a gas inlet 31 of the ammonia decomposition reaction device 3 through a cold liquid channel on the heat exchange device 2, and a gas outlet 32 of the ammonia decomposition reaction device 3 is in communication with the first compression device 4 through a gas channel on the heat exchange device 2, the liquid ammonia discharged from the ammonia storage device 1 is heat-exchanged with the mixed gas discharged from the ammonia decomposition reaction device 3 through the heat exchange device 2, and the heat-exchanged gas is introduced into the first compression device 4. The first adsorption device 5 comprises a plurality of adsorption columns arranged in parallel, an outlet of the first compression device 4 is in communication with adsorption inlets of a plurality of adsorption columns arranged in parallel at the same time, wherein a control valve is provided on a pipeline between the adsorption inlet of each adsorption column and the first compression device 4, the adsorption outlets of a plurality of adsorption columns communicate with each other, a control valve is provided between adsorption outlets of two adjacent adsorption columns, the adsorption inlet of each adsorption column is also in communication with a gas inlet 31 of the ammonia decomposition reaction device 3 through a pipeline, a control valve is provided on a pipeline between the adsorption inlet of each adsorption column and the ammonia decomposition reaction device 3, when the control valves between the adsorption outlets of two adjacent adsorption columns is opened, the mixed gas adsorbed by the adsorption columns is passed into the ammonia decomposition reaction device 3 through one of the adsorption inlets of adsorption columns.

The system for producing hydrogen by ammonia decomposition reaction according to the present application can realize the simultaneous adsorption and desorption of the adsorption columns, and improve the adsorption efficiency of the system by adopting the solution of a plurality of adsorption columns being arranged in parallel; the purge gas purging the adsorption column is returned to the inlet of the ammonia decomposition reactor after being compressed by the compressor, and merges with the preheated ammonia gas before entering the ammonia decomposition reactor to realize ammonia recycling of the desorbed outlet gas, achieving 100% utilization of ammonia; reducing the energy loss of the system and improving the energy utilization rate of the system. The entire system only provides a hydrogen-nitrogen mixed gas (75% H₂+25% N₂) after deep adsorption to remove ammonia, without other tail gas emissions, achieving zero emissions for the entire system, and improving the purity of hydrogen in the mixed gas. The system for producing hydrogen by ammonia decomposition reaction provided by the present invention uses partially adsorbed gas for purging without introducing additional gas sources as purging gas, which reduces the raw material cost of the system and improves the production efficiency of the system.

Furthermore, the heat exchange device 2 comprises a first heat exchanger 21 and a second heat exchanger 22, and the first heat exchanger 21 is provided with a first cold liquid inlet 211, a first cold liquid outlet 212, a first hot gas inlet 213 and a first hot gas outlet 214, the first cold liquid inlet 211 and the first cold liquid outlet 212 serve as a communicated pair, and the first hot gas inlet 213 and the first hot gas outlet 214 serve as a communicated pair; the second heat exchanger 22 is provided with a second cold gas inlet 221, a second cold gas outlet 222, a second hot gas inlet 223 and a second hot gas outlet 224, the second cold gas inlet 221 and the second cold gas outlet 222 serve as a communicated pair, the second hot gas inlet 223 and the second hot gas outlet 224 serve as a communicated pair. The liquid outlet of the ammonia storage device 1 is in communication with the gas inlet 31 of the ammonia decomposition reaction device 3 successively through the first cold liquid inlet 211, the first cold liquid outlet 212, the second cold gas inlet 221 and the second cold gas outlet 222, and gas outlet 32 of the ammonia decomposition reaction device 3 is in communication with an inlet of the first compression device 4 successively through the second hot gas inlet 223, the second hot gas outlet 224, the first hot gas inlet 213 and the first hot gas outlet 214. Specifically, the first cold liquid inlet 211 and the first cold liquid outlet 212 are used to transmit liquid ammonia flowing out of the ammonia storage device 1, and the first hot gas inlet 213 and the first hot gas outlet 214 are used to transmit the mixed gas discharged from the ammonia decomposition reaction device 3 after heat exchange and cooling by the second heat exchanger 22, in which the first heat exchanger 21 can heat the liquid ammonia between the first cold liquid inlet 211 and the first cold liquid outlet 212 to vaporize to form ammonia gas, and the heat exchange element of the first heat exchanger 21 can convert the heat of the mixed gas between the first hot gas inlet 213 and the first hot gas outlet 214 to the liquid ammonia flowing between the first cold liquid inlet 211 and the first cold liquid outlet 212, thereby increasing the temperature of the liquid ammonia to accelerate the vaporization of the liquid ammonia to generate ammonia gas, thereby reducing the heat required for subsequent liquid ammonia heating, reducing heat consumption, and also effectively utilizing the heat generated by the system. In order to further control an amount of ammonia gas flowing into the second heat exchanger 22 so that the ammonia gas can be fully decomposed to generate enough hydrogen, a regulating valve 23 is provided between the first heat exchanger 21 and the second heat exchanger 22, the regulating valve 23 is used to adjust the gas flow rate of the ammonia gas generated by the vaporization of liquid ammonia flowing into the second heat exchanger 22, and then control the flow rate inside the subsequent ammonia decomposition reaction device 3, so that the heat in the second heat exchanger 22 can be full conversion. The second cold gas inlet 221 and the second cold gas outlet 222 are used to transmit the ammonia gas that flows out from the ammonia storage device 1 and is vaporized through the first heat exchanger 21; the second hot gas inlet 223 and the second hot gas outlet 224 are used to transmit the mixed gas discharged from the ammonia decomposition reaction device 3, in which the heat exchange element of the second heat exchanger 22 can further heat the gas heated by the first heat exchanger 21 between the second cold gas inlet 221 and the second cold gas outlet 222 to reach the temperature required for ammonia decomposition, and the heat exchange element of the second heat exchanger 22 can convert the heat of the mixed gas between the second hot gas inlet 223 and the second hot gas outlet 224 to the heat of the ammonia gas flowing between the second cold gas inlet 221 and the second cold gas outlet 222, thereby reducing the energy required to heat the ammonia gas to the ammonia decomposition reaction temperature, achieving the effect of saving energy loss, also effectively utilizing the energy of the gas after ammonia decomposition, and improving system utilization at the same time.

In order to better control the inflow of liquid ammonia, so that the system can adjust the supply of liquid ammonia according to actual production conditions to obtain appropriate and sufficient hydrogen, the outlet of the ammonia storage device 1 is connected to the stop valve 11, and the stop valve 11 is connected to the liquid pump 12. Preferably, the liquid pump 12 is externally connected with a pressure transmission device. Through the pressure transmission device, the liquid pump 12 can adjust the inflow of liquid ammonia according to the pressure of the gas in the system, thereby ensuring that the hydrogen generated by the system reaction can be in a stable range, which improves the stability of the system and also improves the flexibility of the system to ensure that the ammonia decomposition system has sufficient ammonia supply. One end of the liquid pump 12 is in communication with the first cold liquid inlet 211 of the first heat exchanger 21 through a pipe.

A second compression device 6 is also provided on a pipeline between the first adsorption device 5 and the gas inlet of the ammonia decomposition reaction device 3. The ammonia decomposition reaction device 3 is provided with a gas inlet 31 and a gas outlet 32. The gas inlet 31 and the gas outlet 32 are respectively located at both ends of the reaction body of the ammonia decomposition reaction device 3, in which a connecting device 20 is provided at the position of the gas inlet 31 close to the ammonia decomposition reaction device 3. One side of the connecting device 20 is connected to the reaction body of the ammonia decomposition reaction device 3, and the other side of the connecting device 20 is in communication with the second cold gas outlet 222 of the second heat exchanger 22. The discharged ammonia gas from the second heat exchanger, which has reached the ammonia decomposition temperature, and the mixed gas discharged from the second compression device 6 can simultaneously enter the ammonia decomposition reaction device 3 through the connecting device 20 for reaction to decompose the ammonia gas into hydrogen and nitrogen. The gas outlet 32 of the ammonia decomposition reaction device 3 is in communication with the second hot gas inlet 223 of the second heat exchanger 22. The mixed gas of the decomposed hydrogen and nitrogen is then discharged into the second heat exchanger 22 to heat the ammonia gas introduced from the first heat exchanger 21.

After the ammonia gas heated by the second heat exchanger 22 flowing into the interior of ammonia decomposition reaction device 3 through the connecting device 20, it undergoes an ammonia decomposition reaction to generate a mixed gas containing hydrogen, nitrogen and residual ammonia. The mixed gas then is re-introduced into the second hot gas inlet 223 of the second heat exchanger 2 through the gas outlet of the ammonia decomposition reaction device 3, and then the heat of the mixed gas is transferred to the ammonia gas through the second heat exchange element inside the second heat exchanger 22 to reduce the temperature of the mixed gas and increase the temperature of ammonia gas at the same time, thereby reducing energy loss. Since the gas after decomposition of ammonia has a high temperature, in order to further reduce the temperature of the mixed gas, the mixed gas can be suitable for the adsorption of the subsequent adsorption device and the purging of the adsorption column, and improve the adsorption effect and purging effect of the adsorption device. An air cooling device 24 is connected between the second hot gas outlet 224 of the second heat exchanger 22 and the first hot gas inlet 213 of the first heat exchanger 21. The air cooling device 24 is used to further reduce the temperature of the mixed gas discharged from the second heat exchanger 22, which enables the mixed gas to be better used in the subsequent adsorption and purging of the adsorption device, while reducing the energy required to convert heat in the first heat exchanger 22 and improving purging and adsorption effects, and also reducing the overall energy consumption of the system. After being cooled by the air cooling device 24, the cooled mixed gas is then introduced into the first hot gas inlet 213 of the first heat exchanger 21, and then flows through the first heat exchange element inside the first heat exchanger 21. The remaining heat of the cooled mixed gas is transferred by the first heat exchange element to the liquid ammonia to lower the temperature of the mixed gas. The lowered temperature mixed gas is then introduced into the first compression device 4 through the first hot gas outlet 214. The lowered temperature mixed gas is compressed by the first compression device 4 for subsequent adsorption and purging of the first adsorption device 5. Preferably, buffer tanks are provided at both the inlet end and the outlet end of the first compression device 4 to improve the compression effect of the first compression device 4 on the gas.

By arranging the first heat exchanger 21 and the second heat exchanger 22 in series with each other, as well as the regulating valve 23 for adjusting the flow rate, and the air cooling device 24 for cooling the mixed gas, the temperature of the liquid ammonia discharged from the ammonia storage device 1 can be increased, which enables the liquid ammonia to be heated up faster to reach the temperature required for the subsequent ammonia decomposition reaction, thereby improving the efficiency of the ammonia decomposition reaction; at the same time, the heat of the gas discharged from the ammonia decomposition reaction device 3 is transferred by the first heat exchanger 21 and the second heat exchanger 22 to the ammonia gas, which reduces the heat loss of the system and improves the energy utilization rate of the system; and the mixed gas after the ammonia decomposition reaction is heat-exchanged through the first heat exchanger 21 and the second heat exchanger 22, a stable temperature can be reached, which is also conducive to the subsequent adsorption of ammonia in the mixed gas by the first adsorption device 5, thereby improving the purity of hydrogen in the mixed gas.

The first adsorption device 5 comprises a first adsorption column 51 and a second adsorption column 52 arranged in parallel, and a first control valve (a), a second control valve (b), a third control valve (c), a fourth control valve (d), a five control valve (e), a sixth control valve (f) and a seventh control valve (g) which are arranged at an adsorption inlet and an adsorption outlet of the first adsorption device 5, wherein the first adsorption column 51 is provided with a first adsorption inlet 511 and a first adsorption outlet 512, the second adsorption column 52 is provided with a second adsorption inlet 521 and a second adsorption outlet 522, wherein a first pipe 53 is provided between the first adsorption inlet 511 and the second adsorption inlet 521, the first adsorption outlet 512 is in communication with the second adsorption outlet 522 through a second pipe 54, and a third pipe 55 is connected in parallel under the first pipe 53, a fourth pipe 56 is provided on the first adsorption outlet 512, and a fifth pipe 57 is provided on the second adsorption outlet 522; the first control valve (a) is provided between the first compression device 4 and the first adsorption inlet 511, the third control valve (c) is provided between and the first compression device 4 and the second adsorption inlet 521, the fifth control valve (e) is provided on the second pipe 54, the second control valve (b) is provided on the fourth pipe 56, a fourth control valve (d) is provided on the fifth pipe 57, and a sixth control valve (f) is provided between the first adsorption inlet 511 and the ammonia decomposition reaction device 3, and a seventh control valve (g) is provided between the second adsorption inlet 521 and the ammonia decomposition reaction device 3. The first compression device 4 is in communication with the first adsorption inlet 511 of the first adsorption column 51 through the first control valve (a). The first compression device 4 is in communication with the second adsorption inlet 521 of the second adsorption column 52 through the third control valve (c). The first adsorption inlet 511 of the first adsorption column 51 is in communication with the gas inlet 31 of the ammonia decomposition reaction device 3 through the sixth control valve (f). The second adsorption inlet 521 of the second adsorption column 52 is in communication with the gas inlet 31 of the ammonia decomposition reaction device 3 through the seventh control valve (g).

In order to more effectively promote the decomposition reaction of residual ammonia and increase the hydrogen production of the entire system, preferably, a second compression device 6 is provided between the first adsorption device 5 and the gas inlet 31 of the ammonia decomposition reaction device 3. The first adsorption inlet 511 of the first adsorption column 51 is in communication with the second compression device 6 through the sixth control valve (f), and the second adsorption inlet 521 of the second adsorption column 52 is in communication with the second compression device 6 through the seventh control valve (g). Furthermore, in order to improve the compression effect of the second compression device 6, buffer tanks are provided at both the inlet end and the outlet end of the second compression device 6.

After the mixed gas is compressed by the first compression device 4, the mixed gas flows into the first adsorption device 5 through a pipe. At this time, the first control valve (a) is opened, and the mixed gas passes through the first control valve (a) and then flows into the first adsorption column 51 for normal temperature adsorption. Then the second control valve (b), the fifth control valve (e) and the seventh control valve (g) are opened. The adsorbed mixed gas is discharged from the first adsorption column 51 through the second control valve (b), and 5% to 15% of the mixed gas enters the second adsorption column 52 through the second pipe 54 and purges the second adsorption column 52. The purged gas is discharged from the second adsorption column 52 through the seventh control valve (g) and enters the second compression device 6. When the first adsorption column 51 completes the adsorption and reaches saturation, the first control valve (a) and the second control valve (b) are closed, and the third control valve (c), the fifth control valve (e) and the sixth control valve (f) are opened, so that the mixed gas compressed by the first compression device 4 enters the second adsorption column 52 for adsorption. At the same time, 5% to 15% of the mixed gas enters the first adsorption column 51 through the second pipe 54 and purges the first adsorption column 51. At the same time, the fourth control valve (d) is opened, the remaining mixed gas adsorbed by the second adsorption column 52 is discharged from the second adsorption column 52 through the fourth control valve (d), and the purged mixed gas is discharged from the first adsorption column 51 through the sixth control valve (f) and enters the second compression device 6 for further compression. The compressed mixed gas enters the ammonia decomposition reaction device 3 to further decompose the remaining ammonia in the mixed gas, thereby preventing the risk of air pollution caused by ammonia being discharged into the air, and also reducing remaining ammonia gas in the mixed gas, and improving the hydrogen content in the mixed gas.

When the second adsorption column 52 reaches saturation and the first adsorption column 51 completes the purge, adsorption can be performed again. That is, the third control valve (c), the fifth control valve (e) and the sixth control valve (f) are firstly opened, so that the mixed gas after compression passes through the second adsorption column 52 which adsorbs the mixed gas and the first adsorption column 51 is purged. When the second adsorption column 52 reaches saturation, the third control valve (c) is closed, the first control valve (a), the fifth control valve (e) and the seventh control valve (g) are opened, so that the mixed gas passes through the first adsorption column 51 for adsorption and the second adsorption column 52 is purged.

By adopting a plurality of adsorption columns in parallel, and setting control valves between the adsorption outlets of two adjacent adsorption columns, and the adsorption inlets of the adsorption columns communicating with the compression device, the adsorption and purging of the adsorption columns can be performed simultaneously, the adsorption device can always adsorb the mixed gas, thereby reducing the steps of replacing the saturated adsorption column, and improving the adsorption effect and work efficiency of the adsorption device. Further, by connecting the outlets of two adjacent adsorption columns, and adopting adsorbed mixed gas to purge another adsorption column, it effectively utilizes the mixed gas generated by the system, reduces the system's demand and consumption of external nitrogen, thereby reducing the energy loss of the system and improving the energy utilization efficiency of the system, while reducing the emission of harmful gases in the system; the purged gas can be further compressed and enter the ammonia decomposition reaction device for decomposition reaction, thereby improving the gas utilization rate of the system and also improving the hydrogen content in the mixed gas, reducing the ammonia content in the mixed gas and achieving 100% circulation of ammonia. The mixed gas after ammonia decomposition is adsorbed by two adsorption columns in the first adsorption device 5, so that the mixed gas finally discharged from the first adsorption device 5 is a hydrogen-nitrogen mixed gas that has been deeply adsorbed and ammonia removed, thereby reducing the emission of harmful gases. The system for producing hydrogen by ammonia decomposition reaction according to the present invention uses mixed gas and valves to cooperate to purge the adsorption columns, without the need for additional nitrogen purging, which reduces system usage costs.

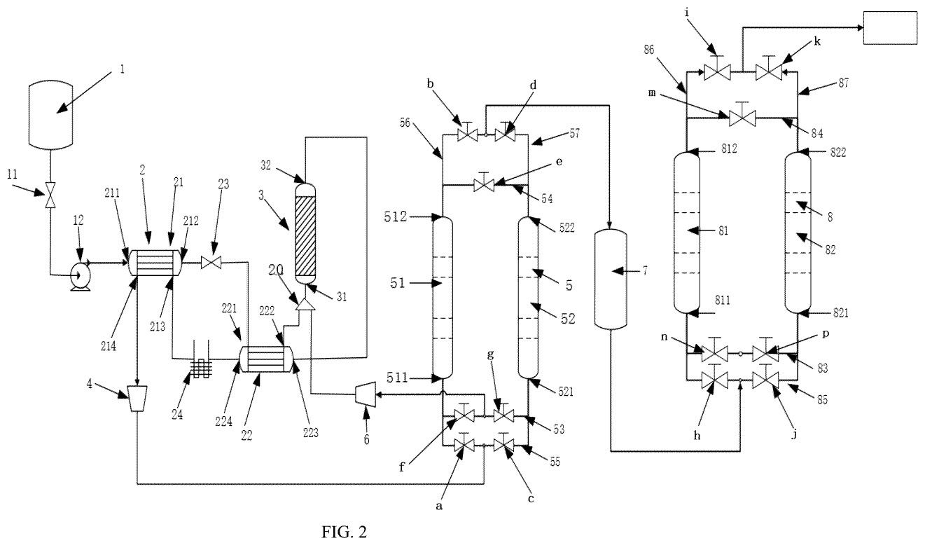

In order to further improve the purity of hydrogen produced by the system for producing hydrogen by ammonia decomposition, improve the system's utilization rate of exhaust gas, and improve the system's adsorption effect and reduce the overall energy consumption of the system at the same time, the system is optimized according to FIG. 2 to FIG. 5.

As shown in FIG. 2, the system further comprises a buffer device 7 and a second adsorption device 8, and the second adsorption device 8 comprises a plurality of adsorption columns arranged in parallel, the adsorption outlet of the adsorption column on the first adsorption device 5 is in communication with one end of the buffer device 7, and the other end of the buffer device 7 is in communication with the adsorption inlet of the adsorption column on the second adsorption device 8. Preferably, the second adsorption device 8 comprises a third adsorption column 81 and a fourth adsorption column 82 arranged in parallel, and an eighth control valve (h), a ninth control valve (i), a tenth control valve (j), an eleventh control valve (k), a twelfth control valve (m), a thirteenth control valve (n) and a fourteenth control valve (p) which are arranged at an adsorption inlet and an adsorption outlet of the second adsorption device 8, wherein the third adsorption column 81 is provided with a third adsorption inlet 811 and a third adsorption outlet 812, the fourth adsorption column 82 is provided with a fourth adsorption inlet 821 and a fourth adsorption outlet 822, wherein a sixth pipe 83 is provided between the third adsorption inlet 811 and the fourth adsorption inlet 821, the third adsorption outlet 812 is in communication with the fourth adsorption outlet 822 through a seventh pipe 84, and an eighth pipe 85 is connected in parallel under the sixth pipe 83, a ninth pipe 86 is in communication with the third adsorption outlet 812, a tenth pipe 87 is in communication with the fourth adsorption outlet 822, the ninth pipe 86 is used to discharge the gas adsorbed by the third adsorption column 81, and the tenth pipe 87 is used to discharge the gas adsorbed by the fourth adsorption column 82; the sixth pipe 83 is provided with the thirteenth control valve (n) near the third adsorption column 81, and the sixth pipe 83 is provided with the fourteenth control valve (p) near the fourth adsorption column 82, the eighth control valve (h) is provided between the buffer device 7 and the third adsorption inlet 811, the tenth control valve (j) is provided between the buffer device 7 and the fourth adsorption inlet 821, the twelfth control valve (m) is provided on the seventh pipe 84, and the ninth control valve (j) is provided on the ninth pipe 86, and the eleventh control valve (k) is provided on the tenth pipe 87.

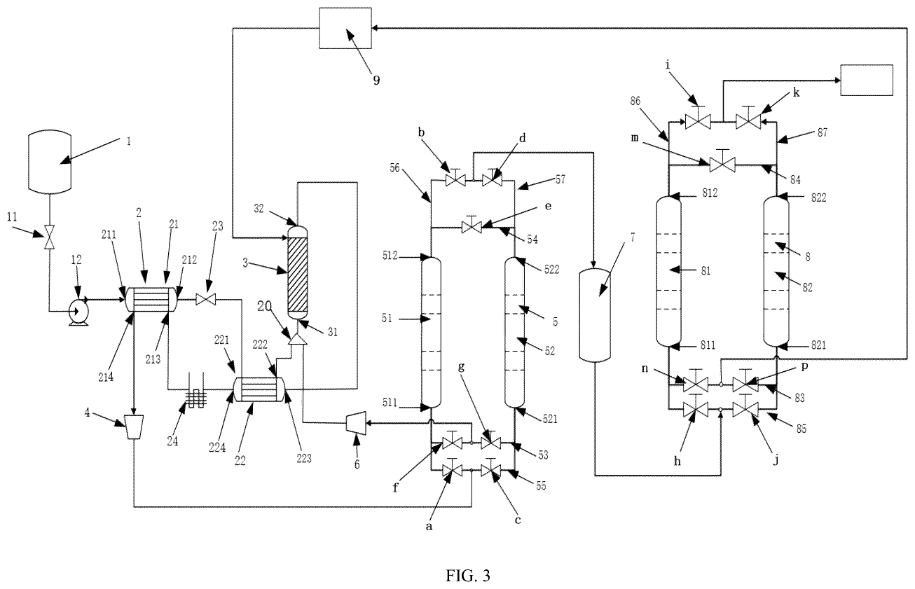

In order to better utilize the gas adsorbed by the third adsorption column 81 or the fourth adsorption column 82, and at the same time reduce the harm of exhaust gas, especially nitrogen oxides, being directly discharged into the air, as shown in FIG. 3, the third adsorption inlet 811 of the third adsorption column 81 and the fourth adsorption inlet 821 of the fourth adsorption column 82 are in communication with an inlet of the combustion device 9 respectively, and an outlet of the combustion device 9 is in communication with the ammonia decomposition reaction device 3. The combustion device 9 can heat and burn the gas used to purge the third adsorption column 81 and the fourth adsorption column 82 to generate combustion gas with a higher temperature, and then introduce the burned gas into the ammonia decomposition reaction device 3 to utilize the heat of the gas itself for providing heat to the ammonia decomposition process, so as to promote a faster and more complete decomposition reaction of ammonia in the ammonia decomposition reaction device 3 to generate hydrogen and nitrogen, thereby better reducing the energy consumption of the system.

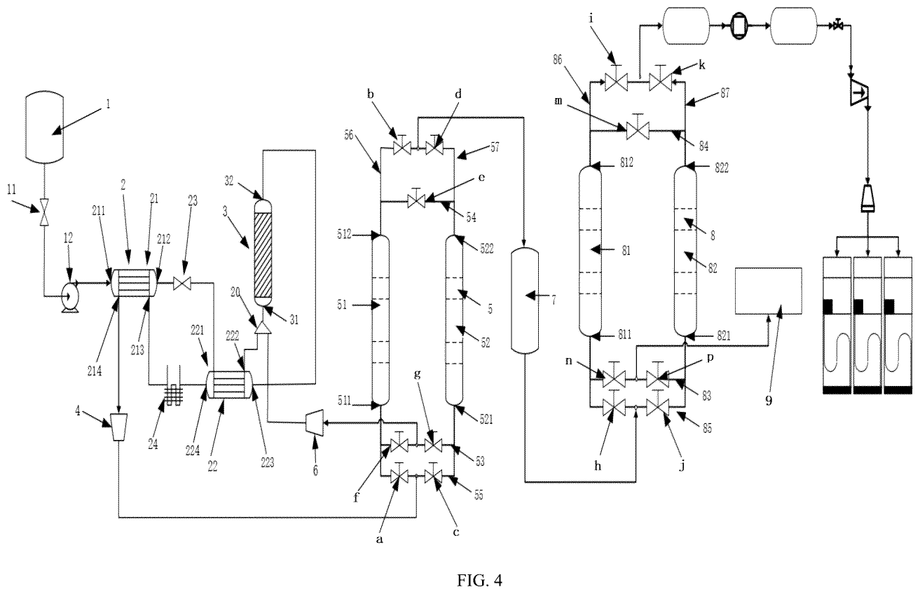

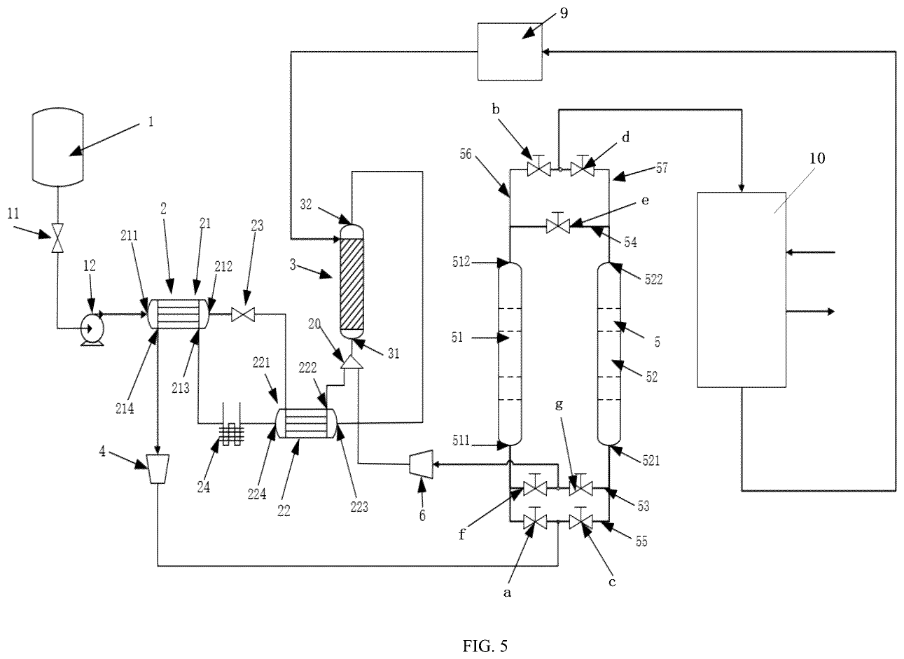

Furthermore, as shown in FIG. 4 and FIG. 5, the ninth pipe 86 and the tenth pipe 87 of the second adsorption device 8 are both in communication with hydrogen energy terminal equipment such as a hydrogen fuel cell or a hydrogenation station. The gas adsorbed by the third adsorption column 81 and the fourth adsorption column 82 can be introduced by the ninth pipe 86 and the tenth pipe 87 of the second adsorption device 8 into the hydrogen energy terminal equipment for use as fuel. As shown in FIG. 5, when the hydrogen energy terminal device is a hydrogen fuel cell 10, one end of the hydrogen energy terminal device is in communication with the combustion device 9, and the other end of the combustion device 9 is in communication with the ammonia decomposition reaction device 3. The exhaust gas emitted by the hydrogen fuel cell 10 can be burned by the combustion device 9, and the burned gas is introduced into the ammonia decomposition reaction device 3 to heat the ammonia gas. It not only effectively utilizes the exhaust gas of the hydrogen fuel cell, but also reduces environmental pollution caused by tail gas emissions of the hydrogen fuel cell.

Similarly, when the first adsorption device 5 is in communication with the second adsorption device 8, the mixed gas adsorbed by the first adsorption device 5 flows into the buffer device 7, and is discharged into the second adsorption device 8 after being buffered by the buffer device 7. At this time, the eighth control valve (h) is firstly opened, and the mixed gas passes through the first control valve (a) and enters the third adsorption column 81 for air pressure adsorption. Then the ninth control valve (i), the twelfth control valve (m) and the fourteenth control valve (p) are opened. The mixed gas after the adsorption is discharged from the third adsorption column 81 through the ninth control valve (i). The mixed gas also purges the fourth adsorption column 82 through the twelfth control valve (m), and then is discharged from the second adsorption device 8 through the fourteenth control valve (p). When the third adsorption column 81 completes the adsorption and reaches saturation, the eighth control valve (h) and the ninth control valve (i) are closed, and the tenth control valve (j), the eleventh control valve (k), the twelfth control valve (m) and the thirteenth control valve (n) are opened, so that the buffered mixed gas enters the fourth adsorption column 82 for adsorption, and the third adsorption column 81 is purged through the twelfth control valve (m). The purged gas is discharged from the third adsorption column 81 through the thirteenth control valve (n).

When the fourth adsorption column 82 reaches saturation and the third adsorption column 81 completes the purge, adsorption can be performed again. That is, the tenth control valve (j) and the twelfth control valve (m) are firstly opened, so that the mixed gas after compression passes through the fourth adsorption column 82 for adsorption and the third adsorption column 81 is purged. When the fourth adsorption column 82 reaches saturation, the tenth control valve (j) is closed, and the eighth control valve (h) and the twelfth control valve (m) are opened, so that the mixed gas passes through the third adsorption column 81 for adsorption and the fourth adsorption column 82 is purged.

In addition, the present invention also discloses a hydrogen production method using the system for producing hydrogen by ammonia decomposition reaction. The specific steps are as follows:
S1. introducing liquid ammonia in the ammonia storage device 1 into the heat exchange device 2, and heating the liquid ammonia to above 550° C.;
S2. introducing ammonia gas above 550° C. in the heat exchange device 2 into the ammonia decomposition reaction device 3 to perform ammonia decomposition reaction;
S3. discharging the mixed gas decomposed by the ammonia decomposition reaction device 3 from the ammonia decomposition reaction device 3 and introducing it into the heat exchange device 2 and cooling the mixed gas to room temperature;
S4, introducing the mixed gas cooled to room temperature into the first compression device 4 for compression;
S5. introducing the mixed gas compressed by the first compression device 4 into the first adsorption column 51 of the first adsorption device 5, so that the first adsorption column 51 adsorbing the mixed gas until the first adsorption column 21 reaching a saturated state, and while adsorbing, 5% to 15% of the mixed gas in the first adsorption column 51 being directed to the second adsorption column 52 to purge the second adsorption column 52;
S6. discharging the purged mixed gas from the second adsorption column 52 and re-introducing it into the ammonia decomposition reaction device 3 to perform the ammonia decomposition reaction;
S7, introducing the mixed gas compressed by the first compression device 4 into the second adsorption column 52 of the first adsorption device 5, so that the second adsorption column 52 adsorbing the mixed gas until the second adsorption column 52 reaching a saturated state, and while adsorbing, 5-15% of the mixed gas in the second adsorption column 52 being directed to the first adsorption column 51 to purge the first adsorption column 51;
S8. discharging the purged mixed gas from the second adsorption column 52, and re-introducing it into the ammonia decomposition reaction device 3 for the ammonia decomposition reaction;
S9. performing steps S5-S8 repeatedly in a circulating mode.

In step S5, the first control valve (a) of the first adsorption device 5 is opened, the mixed gas is introduced into the first adsorption column 51 through the corresponding connected pipe, and the fifth control valve (e) of the first adsorption device 5 is opened at the same time. 5% to 15% of the mixed gas is introduced into the second adsorption column 52 for purging; the remaining gas is led out of the first adsorption column 51 through the second control valve (b) for subsequent gas collection and utilization. In step S6, the purged gas is discharged from the first adsorption device 5 through the seventh control valve (g) and enters the ammonia decomposition reaction device 3. In step S7, the third control valve (c) of the first adsorption device 5 is opened and the mixed gas is introduced through the corresponding connected pipe into the second adsorption column 52 for adsorption, and at the same time, the fifth control valve (e) of the first adsorption device 5 is opened, and 5% to 15% of the mixed gas is directed to the first adsorption column 51 through the fifth control valve (e) for purging. The remaining gas is discharged through the fourth control valve (d). In step S8, the purged gas is discharged from the first adsorption device 5 through the sixth control valve (f) and enters the ammonia decomposition reaction device 3.

Similarly, the second adsorption column 52 may be adsorbed firstly and the first adsorption column 51 may be purged firstly. When the second adsorption column 52 is saturated, the first adsorption column 51 is adsorbed and the second adsorption column 52 is purged at the same time. After the purging is completed, the purged gas is introduced into the ammonia decomposition reaction device 3 through the seventh control valve (g) and the sixth control valve (f) to complete the reuse of the purged gas.

Obviously, the above-mentioned embodiments are only examples for clear explanation and are not intended to limit the implementation. For those skilled in the art, other different forms of changes or modifications can be made based on the above description. An exhaustive list of all implementations is neither necessary nor possible. The obvious changes or modifications derived therefrom are still within the protection scope of the present invention.

1. A system for producing hydrogen by ammonia decomposition reaction, comprising an ammonia storage device (1), a heat exchange device (2), an ammonia decomposition reaction device (3), a first compression device (4) and a first adsorption device (5), wherein a liquid outlet of the ammonia storage device (1) is in communication with a gas inlet (31) of the ammonia decomposition reaction device (3) through a cold liquid channel on the heat exchange device (2), and a gas outlet (32) of the ammonia decomposition reaction device (3) is in communication with the first compression device (4) through a gas channel on the heat exchange device (2), the liquid ammonia discharged from the ammonia storage device (1) is heat-exchanged with the mixed gas discharged from the ammonia decomposition reaction device (3) through the heat exchange device (2), and the heat-exchanged gas is introduced into the first compression device (4);
the first adsorption device (5) comprises a plurality of adsorption columns arranged in parallel, an outlet of the first compression device (4) is in communication with adsorption inlets of a plurality of adsorption columns arranged in parallel at the same time, wherein a control valve is provided on a pipeline between the adsorption inlet of each adsorption column and the first compression device (4), the adsorption outlets of a plurality of adsorption columns communicate with each other, a control valve is provided between adsorption outlets of two adjacent adsorption columns, the adsorption inlet of each adsorption column is also in communication with a gas inlet (31) of the ammonia decomposition reaction device (3) through a pipeline, a control valve is provided on a pipeline between the adsorption inlet of each adsorption column and the ammonia decomposition reaction device (3), when the control valves between the adsorption outlets of two adjacent adsorption columns is opened, the mixed gas adsorbed by the adsorption columns is passed into the ammonia decomposition reaction device (3) through one of the adsorption inlets of adsorption columns.

2. The system for producing hydrogen by ammonia decomposition reaction according to claim 1, wherein the heat exchange device (2) comprises a first heat exchanger (21) and a second heat exchanger (22), and the first heat exchanger (21) is provided with a first cold liquid inlet (211), a first cold liquid outlet (212), a first hot gas inlet (213) and a first hot gas outlet (214), the first cold liquid inlet (211) and the first cold liquid outlet (212) serve as a communicated pair, and the first hot gas inlet (213) and the first hot gas outlet (214) serve as a communicated pair; the second heat exchanger (22) is provided with a second cold gas inlet (221), a second cold gas outlet (222), a second hot gas inlet (223) and a second hot gas outlet (224), the second cold gas inlet (221) and the second cold gas outlet (222) serve as a communicated pair, the second hot gas inlet (223) and the second hot gas outlet (224) serve as a communicated pair, the liquid outlet of the ammonia storage device (1) is in communication with the gas inlet (31) of the ammonia decomposition reaction device (3) successively through the first cold liquid inlet (211), the first cold liquid outlet (212), the second cold gas inlet (221) and the second cold gas outlet (222), and gas outlet (32) of the ammonia decomposition reaction device (3) is in communication with an inlet of the first compression device (4) successively through the second hot gas inlet (223), the second hot gas outlet (224), the first hot gas inlet (213) and the first hot gas outlet (214).

3. The system for producing hydrogen by ammonia decomposition reaction according to claim 2, wherein a second compression device (6) is also provided on a pipeline between the first adsorption device (5) and the gas inlet of the ammonia decomposition reaction device (3);
a regulating valve (23) is provided on a pipeline between the first cold liquid outlet (212) and the second cold gas inlet (221); and an air cooling device (24) is also provided on a pipeline between the second hot gas outlet (224) and the first hot gas inlet (221).

4. The system for producing hydrogen by ammonia decomposition reaction according to claim 3, wherein an inlet end and an outlet end of the first compression device (4), and an inlet end and an outlet end of the second compression device are provided with buffer tanks.

5. The system for producing hydrogen by ammonia decomposition reaction according to claim 1, wherein the first adsorption device (5) comprises a first adsorption column (51) and a second adsorption column (52) arranged in parallel, and a first control valve (a), a second control valve (b), a third control valve (c), a fourth control valve (d), a five control valve (e), a sixth control valve (f) and a seventh control valve (g) which are arranged at an adsorption inlet and an adsorption outlet of the first adsorption device (5), wherein the first adsorption column (51) is provided with a first adsorption inlet (511) and a first adsorption outlet (512), the second adsorption column (52) is provided with a second adsorption inlet (521) and a second adsorption outlet (522), wherein a first pipe (53) is provided between the first adsorption inlet (511) and the second adsorption inlet (521), the first adsorption outlet (512) is in communication with the second adsorption outlet (522) through a second pipe (54), and a third pipe (55) is connected in parallel under the first pipe (53), a fourth pipe (56) is provided on the first adsorption outlet (512), and a fifth pipe (57) is provided on the second adsorption outlet (522); the first control valve (a) is provided between the first compression device (4) and the first adsorption inlet (511), the third control valve (c) is provided between and the first compression device (4) and the second adsorption inlet (521), the fifth control valve (e) is provided on the second pipe (54), the second control valve (b) is provided on the fourth pipe (56), a fourth control valve (d) is provided on the fifth pipe (57), and a sixth control valve (f) is provided between the first adsorption inlet (511) and the ammonia decomposition reaction device (3), and a seventh control valve (g) is provided between the second adsorption inlet (521) and the ammonia decomposition reaction device (3).

6. The system for producing hydrogen by ammonia decomposition reaction according to claim 1, wherein the system further comprises a buffer device (7) and a second adsorption device (8), and the second adsorption device (8) comprises a plurality of adsorption columns arranged in parallel, the adsorption outlet of the adsorption column on the first adsorption device (5) is in communication with one end of the buffer device (7), and the other end of the buffer device (7) is in communication with the adsorption inlet of the adsorption column on the second adsorption device (8).

7. The system for producing hydrogen by ammonia decomposition reaction according to claim 6, wherein the second adsorption device (8) comprises a third adsorption column (81) and a fourth adsorption column (82) arranged in parallel, and an eighth control valve (h), a ninth control valve (i), a tenth control valve (j), an eleventh control valve (k), a twelfth control valve (m), a thirteenth control valve (n) and a fourteenth control valve (p) which are arranged at an adsorption inlet and an adsorption outlet of the second adsorption device (8), wherein the third adsorption column (81) is provided with a third adsorption inlet (811) and a third adsorption outlet (812), the fourth adsorption column (82) is provided with a fourth adsorption inlet (821) and a fourth adsorption outlet (822), wherein a sixth pipe (83) is provided between the third adsorption inlet (811) and the fourth adsorption inlet (821), the third adsorption outlet (812) is in communication with the fourth adsorption outlet (822) through a seventh pipe (84), and an eighth pipe (85) is connected in parallel under the sixth pipe (83), a ninth pipe (86) is in communication with the third adsorption outlet (812), a tenth pipe (87) is in communication with the fourth adsorption outlet (822); the sixth pipe (83) is provided with the thirteenth control valve (n) near the third adsorption column (81), and the sixth pipe (83) is provided with the fourteenth control valve (p) near the fourth adsorption column (82), the eighth control valve (h) is provided between the buffer device (7) and the third adsorption inlet (811), the tenth control valve (j) is provided between the buffer device (7) and the fourth adsorption inlet (821), the twelfth control valve (m) is provided on the seventh pipe (84), and the ninth control valve (j) is provided on the ninth pipe (86), and the eleventh control valve (k) is provided on the tenth pipe (87).

8. The system for producing hydrogen by ammonia decomposition reaction according to claim 7, wherein the system further comprises a combustion device (9), the third adsorption inlet (811) of the third adsorption column (81) and the fourth adsorption inlet (821) of the fourth adsorption column (82) are in communication with an inlet of the combustion device (9) respectively, and an outlet of the combustion device (9) is in communication with the ammonia decomposition reaction device (3).

9. The system for producing hydrogen by ammonia decomposition reaction according to claim 8, wherein the system further comprises a hydrogen fuel cell (10), and the adsorption outlet of the first adsorption device (5) is in communication with the hydrogen fuel cell (10), an outlet end of the hydrogen fuel cell (10) is in communication with the inlet of the combustion device (9), and the outlet of the combustion device (9) is in communication with the ammonia decomposition reaction device (3).

10. A hydrogen production method adopting a system for producing hydrogen by ammonia decomposition reaction, wherein the hydrogen production method comprises the following steps:
S1. introducing liquid ammonia into a heat exchange device (2) and heating the liquid ammonia to above 550° C.;
S2. introducing ammonia gas into an ammonia decomposition reaction device (3) to perform ammonia decomposition reaction;
S3. discharging a decomposed mixed gas from the ammonia decomposition reaction device (3) and cooling the decomposed mixed gas to room temperature;
S4. introducing a cooled mixed gas into a first compression device (4) for compression;
S5. introducing the mixed gas compressed by the first compression device (4) into a first adsorption column (51) of a first adsorption device (5), so that the first adsorption column (51) adsorbing the mixed gas until the first adsorption column (51) reaching a saturated state, and while adsorbing, 5% to 15% of the mixed gas in the first adsorption column (51) being directed to a second adsorption column (52) to purge the second adsorption column (52);
S6. discharging the purged mixed gas from the second adsorption column (52), and re-introducing it into the ammonia decomposition reaction device (3) to perform the ammonia decomposition reaction;
S7. introducing the mixed gas compressed by the first compression device (4) into the second adsorption column (52) of the adsorption device, so that the second adsorption column (52) adsorbing the mixed gas until the second adsorption column (52) reaching a saturated state, and while adsorbing, 5% to 15% of the mixed gas in the second adsorption column (52) being directed to the first adsorption column (51) to purge the first adsorption column (52);
S8. discharging the purged mixed gas from the first adsorption column (51), and re-introducing it into the ammonia decomposition reaction device (3) for ammonia decomposition reaction;
S9. performing steps S5-S8 repeatedly in a circulating mode.
